(19) United States
(12) Patent Application Publication
(10) Pub. No.: US 2026/0096940 A1
(43) Pub. Date: Apr. 9, 2026

(54) AUTONOMOUS MOBILE ROBOT (AMR) WHEELCHAIR CAPABLE OF ACHIEVING AUTONOMOUS MONITORING, OPERATION, AND GUIDANCE

(71) Applicant: Sonne International Company Limited, HK (HK)

(72) Inventor: Bik Kwan Bikie Wong, Hong Kong (HK)

(21) Appl. No.: 18/933,305

(22) Filed: Oct. 31, 2024

(30) Foreign Application Priority Data
Oct. 8, 2024 (CN) 202422416351.2

(51) Int. Cl. A61G 5/10; A61G 5/04; A61G 5/12; G05D 1/246; G05D 1/622; G05D 105/22

(52) U.S. Cl. CPC A61G 5/1051; A61G 5/047; A61G 5/1078; A61G 5/125; A61G 5/128; G05D 1/2469; G05D 1/622; A61G 2203/22; G05D 2105/24

(57) ABSTRACT

An autonomous mobile robot (AMR) wheelchair capable of achieving autonomous monitoring, operation, and guidance includes a wheelchair frame, fixed moving wheels mounted on front and rear sides of a bottom of the wheelchair frame to achieve movement of the wheelchair, a foot rest mounted at a front part of the wheelchair frame to support the feet of a user, and arm rests arranged on two sides of the wheelchair frame. The front moving wheels further has a function of adjusting a travelling direction of the wheelchair. Connecting frames are arranged at the bottom of the wheelchair frame; the connecting frames are movably provided with clamping frames; and an AMR device is clamped and released by adjusting a distance between the two clamping frames, without another auxiliary tool, thereby achieving an effect of conveniently removing the AMR device and facilitating updating and maintenance of the AMR device.

### TECHNICAL FIELD

The present disclosure relates to a wheelchair, and in particular, to an autonomous mobile robot (AMR) wheelchair capable of achieving autonomous monitoring, operation, and guidance.

### BACKGROUND

An Autonomous Mobile Robot (AMR) wheelchair is a highly intelligent assistive device designed to provide autonomous navigation and mobility for people with limited mobility. This wheelchair combines an advanced robot technology, a sensor technology, and an artificial intelligence algorithm, and can achieve autonomous navigation and avoid obstacles in complex environments and interact with users.

With the advancement of technology and the increasing demand of the society for accessible transportation, AMR wheelchair sharing is expected to become a universal service form. As a key component of the AMR wheelchair, an AMR device can achieve autonomous monitoring, operation, and guidance on a path. The existing AMR device is generally mounted at the bottom of the wheelchair in a relatively fixed manner, which leads to many inconveniences in updating and maintenance.

Based on this, it is necessary to design an AMR wheelchair capable of achieving monitoring, operation, and guidance, so as to conveniently remove an AMR device and achieve an effect of conveniently maintaining the AMR device.

### SUMMARY

The technical solution of the present disclosure is as follows: An autonomous mobile robot (AMR) wheelchair capable of achieving autonomous monitoring, operation, and guidance includes a wheelchair frame, fixed moving wheels mounted on front and rear sides of a bottom of the wheelchair frame to achieve movement of the wheelchair, a foot rest mounted at a front part of the wheelchair frame to support the feet of a user, and arm rests arranged on two sides of the wheelchair frame. The AMR wheelchair further includes connecting frames arranged at the bottom of the wheelchair frame and a pair of clamping frames movably arranged on the connecting frames. The pair of clamping frames approach each other or move away from each other to clamp or release an AMR device below the foot rest, wherein the two clamping frames move away from each other to release the AMR device, so that the AMR device is conveniently separated from the two clamping frames. The AMR wheelchair further includes a monitoring system and a guide system arranged in the AMR device. The monitoring system dynamically plans an optimal path from a start point to an end point according to positioning information of a pickup point and a get-off point in the AMR device and real-time environment information. Further, the guide system performs obstacle avoidance guidance on a detected obstacle to achieve safe passing. Moreover, clamping blocks are slidably arranged on the clamping frames, and the clamping blocks are configured to limit the AMR device on a placement platform formed by the two clamping frames.

In an embodiment, the monitoring system includes a sensor configured to monitor an environment in real time and acquire corresponding data, a positioning device for tracking a real-time position of the AMR wheelchair, and an algorithm unit for planning a travel path in real time in conjunction with an environmental topographic map constructed by the acquired real-time data and roadblock information fed back by an obstacle avoidance system.

In an embodiment, the monitoring system further includes a monitoring and operation unit configured to monitor a state of the AMR wheelchair and to monitor a fault.

In an embodiment, the clamping frames are connected to the connecting frames in a manner of being slidably connected to electric sliding rails slidably arranged on the connecting frames.

In an embodiment, a two-directional adjustment screw rod and a first guide rod are movably arranged on top of the two clamping frames. The two-directional adjustment screw rod and the first guide rod are parallel to each other and the two-directional adjustment screw rod is configured to drive the two clamping frames to approach or move away from each other.

In an embodiment, a second guide rod is arranged on an outer wall of each clamping frame. The second guide rods slidably penetrates through the clamping blocks, and the clamping blocks slide through the clamping frames; and elastic members are arranged between end portions of the second guide rods and the clamping blocks.

In an embodiment, antiskid sleeves are arranged at push handles of the wheelchair frame.

In an embodiment, shock absorbers for absorbing shock are arranged at joints between the moving wheels and the wheelchair frame.

In an embodiment, two outer walls of the connecting frames are hinged with supporting plates. Further, cylinders for driving the supporting plates to flip are arranged at bottoms of the connecting frames, and movable ends of piston rods of the cylinders are connected to the supporting plates.

In an embodiment, antiskid pads are arranged at bottoms of the supporting plates.

In an embodiment, flip angle of each supporting plate is less than 90 degrees.

In an embodiment, ends of the clamping blocks that slide through the clamping frames are slopes and orientations of the slopes are consistent with the travelling direction of the wheelchair.

Beneficial effects are as follows: The AMR device is clamped and released by adjusting a distance between the two clamping frames. When the distance between the two clamping frames increases, the clamping function of the clamping frames on the AMR device is released. At this time, the AMR device can be conveniently removed from the position between the two clamping frames, without any auxiliary tools, thereby achieving an effect of conveniently removing the AMR device and facilitating updating and maintenance of the AMR device. The monitoring system and the guide system are arranged in the AMR device to dynamically plan an optimal path from a start point to an end point. The guide system performs obstacle avoidance guidance on a detected obstacle to achieve safe passing.

### BRIEF DESCRIPTION OF THE DRAWINGS

FIG. 1 is a schematic diagram of a three-dimensional structure of the present disclosure.

FIG. 2 is a cross-sectional diagram of a three-dimensional structure of a wheelchair frame and a foot rest according to the present disclosure.

FIG. 3 is an enlarged view of the part A in FIG. 2 of the present disclosure.

FIG. 4 is an enlarged view of the part B in FIG. 2 of the present disclosure.

FIG. 5 is a cross-sectional diagram of a three-dimensional structure of a supporting plate and an antiskid pad according to the present disclosure.

Numerals in the accompanying drawings: 1: moving wheel; 2: wheelchair frame; 201: connecting frame; 3: antiskid sleeve; 4: foot rest; 5: arm rest; 6: shock absorber; 7: supporting plate; 701: antiskid pad; 702: cylinder; 8: first guide rod; 9: clamping block; 901: second guide rod; 902: spring; 10: clamping frame; 1001: electric sliding rail; 11: two-directional adjustment screw rod; and 12: AMR device.

### DETAILED DESCRIPTION OF THE INVENTION

The following will describe the embodiments of the present disclosure in detail in conjunction with the accompanying drawings.

An autonomous mobile robot (AMR) wheelchair capable of achieving autonomous monitoring, operation, and guidance includes a wheelchair frame 2, fixed moving wheels 1 mounted on front and rear sides of a bottom of the wheelchair frame 2 to achieve movement of the wheelchair, a foot rest 4 mounted at a front part of the wheelchair frame 2 to support the feet of a user, and arm rests 5 arranged on two sides of the wheelchair frame 2. The AMR wheelchair further includes connecting frames 201 arranged at the bottom of the wheelchair frame 2 and a pair of clamping frames 10 movably arranged on the connecting frames 201. The pair of clamping frames 10 approach each other or move away from each other to clamp or release an AMR device 12 below the foot rest 4. The two clamping frames 10 move away from each other to release the AMR device 12, so that the AMR device 12 is conveniently separated from the two clamping frames 10. A monitoring system and a guide system are arranged in the AMR device 12. The monitoring system dynamically plans an optimal path from a start point to an end point according to positioning information of a pickup point and a get-off point in the AMR device 12 and real-time environment information. The guide system performs obstacle avoidance guidance on a detected obstacle to achieve safe passing. The monitoring system includes a sensor configured to monitor an environment in real time and acquire corresponding data, a positioning device for tracking a real-time position of the AMR wheelchair, and an algorithm unit for planning a travel path in real time in conjunction with an environmental topographic map constructed by the acquired real-time data and roadblock information fed back by an obstacle avoidance system. In a specific embodiment, high-precision distance measurement is performed using a LiDAR to construct a point cloud map of a surrounding environment. Visual recognition and detection of objects, pedestrians, and other obstacles are carried out through a camera. Obstacles are detected through ultrasonic sensors within a close range to achieve real-time monitoring of the environment and record corresponding data. Meanwhile, the monitoring system is further provided with a positioning device. The monitoring system constructs an environmental map through the real-time monitored data of the environment and the positioning device and determines a position of a robot. The monitoring system further includes a monitoring and operation unit configured to monitor a state of the AMR wheelchair and to monitor a fault. The monitoring of the state of the AMR wheelchair includes monitoring a battery level and monitoring a state of the sensor configured to acquire environmental information. The monitoring and operation unit for monitoring the fault of the AMR wheelchair is configured to automatically switch to a backup or safe mode when a fault is detected in the AMR wheelchair.

Clamping blocks 9 are slidably arranged on the clamping frames 10. The clamping blocks 9 are configured to limit the AMR device 12 on a placement platform formed by the two clamping frames 10.

Further, the clamping frames 10 are connected to the connecting frames 201 in a manner of being slidably connected to electric sliding rails 1001 slidably arranged on the connecting frames 201.

Further, a two-directional adjustment screw rod 11 and a first guide rod 8 are movably arranged on top of the two clamping frames 10; the two-directional adjustment screw rod 11 and the first guide rod 8 are parallel to each other; and the two-directional adjustment screw rod 11 is configured to drive the two clamping frames 10 to approach or move away from each other.

Further, a second guide rod 901 is arranged on an outer wall of each clamping frame 10; the second guide rods 901 slidably penetrate through the clamping blocks 9, and the clamping blocks 9 slide through the clamping frames 10; and elastic members are arranged between end portions of the second guide rods 901 and the clamping blocks 9.

Further, antiskid sleeves 3 are arranged at push handles of the wheelchair frame 2.

Further, shock absorbers 6 for absorbing shock are arranged at joints between the moving wheels 1 and the wheelchair frame 2.

Further, two outer walls of the connecting frames 201 are hinged with supporting plates 7; cylinders 702 for driving the supporting plates 7 to flip are arranged at bottoms of the connecting frames 201; and movable ends of piston rods of the cylinders 702 are connected to the supporting plates 7.

Further, antiskid pads 701 are arranged at bottoms of the supporting plates 7.

Further, a flip angle of each supporting plate 7 is less than 90 degrees.

Further, ends of the clamping blocks 9 that slide through the clamping frames 10 are slopes; and orientations of the slopes are consistent with the travelling direction of the wheelchair.

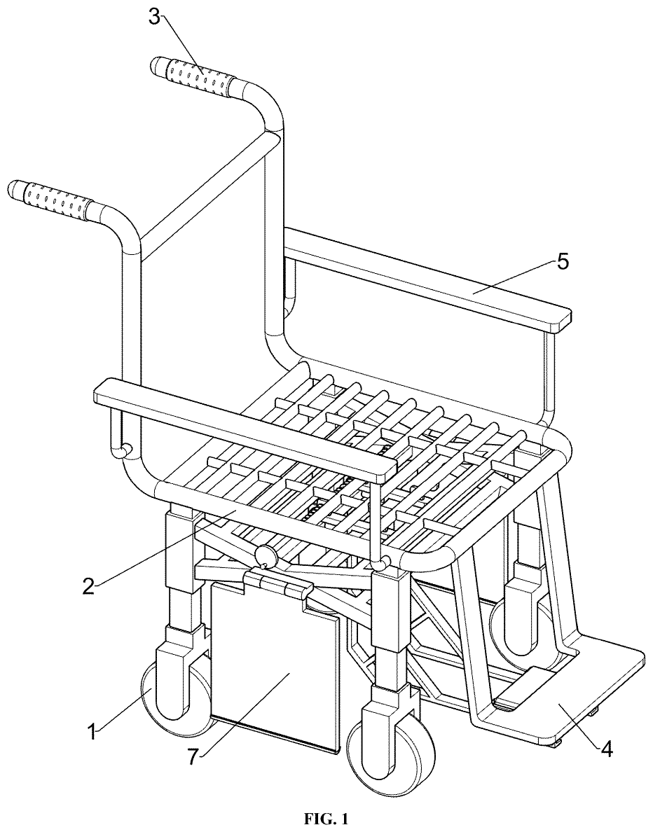

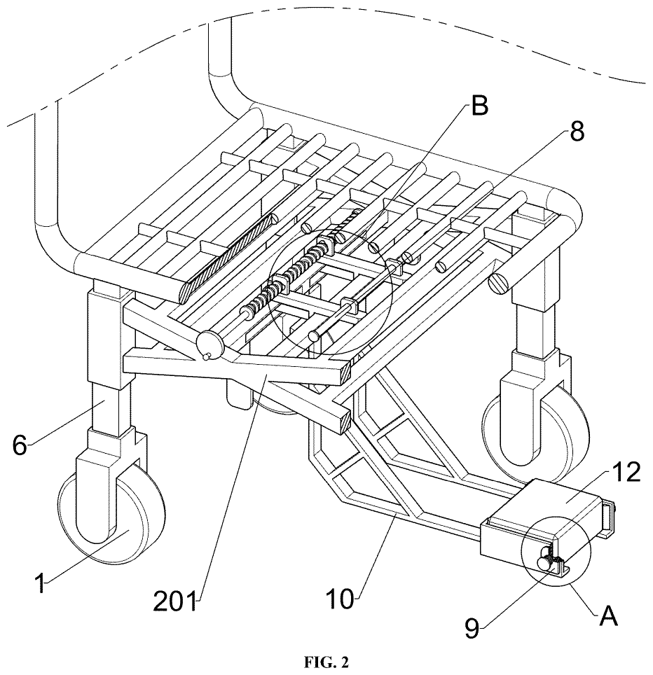

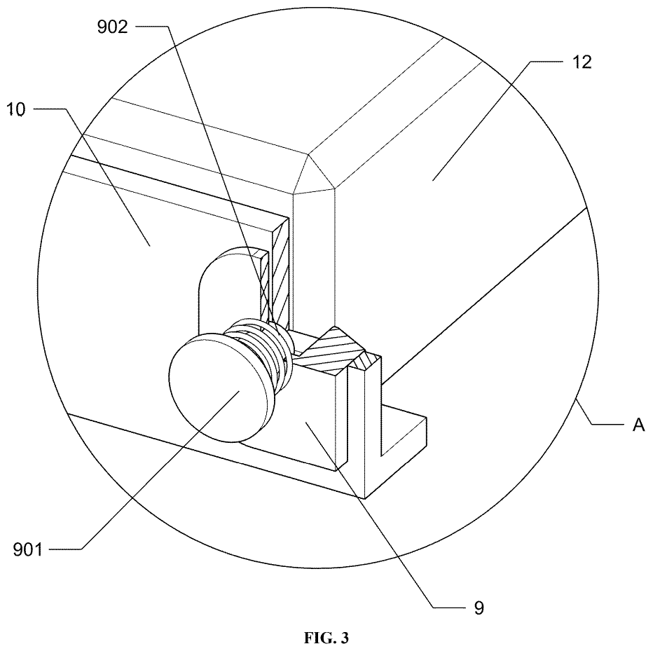

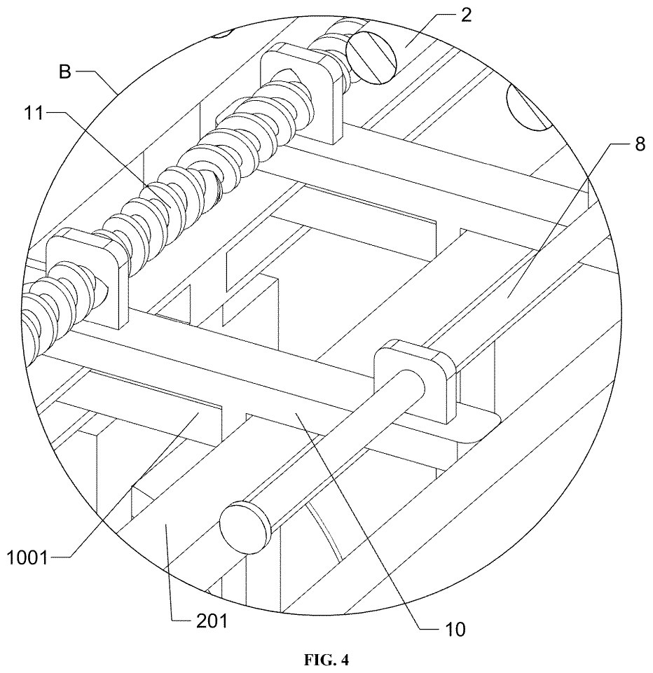

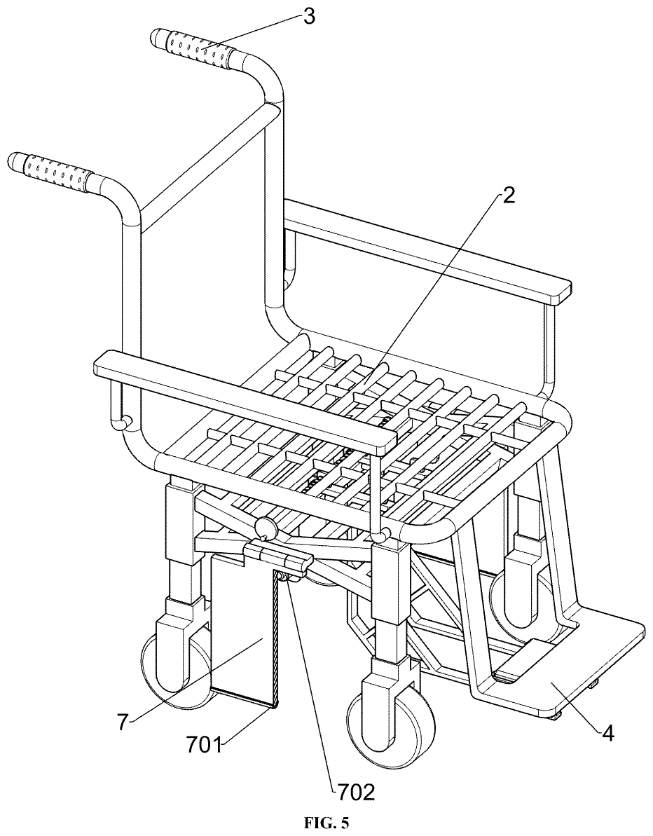

In a specific embodiment, as shown in FIG. 1 to FIG. 5, the present disclosure provides an AMR wheelchair capable of achieving autonomous monitoring, operation, and guidance. The AMR wheelchair includes a wheelchair frame 2, fixed moving wheels 1 mounted on front and rear sides of a bottom of the wheelchair frame 2 to achieve movement of the wheelchair, a foot rest 4 mounted on a front part of the wheelchair frame 2 to support the feet of a user, and arm rests 5 arranged on left and right sides of the wheelchair frame 2. The front moving wheels 1 further have a function of adjusting a travelling direction of the wheelchair. Shock absorbers 6 for absorbing shock are arranged at the joints between the moving wheels 1 and the wheelchair frame 2 to improve the stability of the wheelchair. Antiskid sleeves 3 are arranged at push handles at a rear part of the wheelchair frame 2 to provide stable gripping power during manual push of the AMR wheelchair. The AMR wheelchair further includes connecting frames 201 arranged at the bottom of the wheelchair frame 2. The connecting frames 201 are movably provided with a pair of clamping frames 10. Longitudinal sections of sides of lower parts of the clamping frames 10 close to each other are L-shaped. The AMR device 12 is clamped or released by the two clamping frames 10 that approach each other or move away from each other. When the two clamping frames 10 approach each other, the two clamping frames 10 form a placement platform, so that the AMR device 12 can be separately placed on the platform. The AMR device 12 can be clamped and fixed by the two clamping frames 10 approaching each other. When the two clamping frames 10 move away from each other to release the AMR device 12, the AMR device 12 can be easily separated from the two clamping frames 10 to achieve an effect of convenient removal. The monitoring system and the guide system are arranged in the ARM device 12. The monitoring system dynamically plans an optimal path from the start point to the end point according to positioning information of the pickup point and the get-off point in the AMR device 12 and real-time environment information. The guide system performs obstacle avoidance guidance on a detected obstacle to achieve safe passing. Clamping blocks 9 are slidably arranged on the clamping frames 10; and the clamping blocks 9 are configured to limit a front end of the AMR device 12, so that the AMR device 12 is stably placed between the two clamping frames 10.

It is worth noting that the monitoring system is arranged in the AMR device 12. The position of the wheelchair is obtained in real time through a positioning device arranged on the AMR wheelchair. By use of a simultaneous positioning and map construction technology, the wheelchair can autonomously create a map in an unknown environment for navigation and plan an optimal path from a start point to an end point based on the created map. Thus, the AMR wheelchair can achieve autonomous monitoring on the path and avoid obstacles. In this embodiment, the guide system monitors obstacles in front of the AMR wheelchair, sounds an alarm upon detecting the obstacles, and changes a travelling direction of the AMR wheelchair, thereby achieving safe passing of the AMR wheelchair. In a specific embodiment, the guide system integrates various sensors such as a LiDAR, a camera, and an ultrasonic sensor to achieve comprehensive environmental perception.

Sliding chutes are provided in horizontal rodlike members on two sides of a center line of an upper part of each connecting frame 201, and electric sliding rails 1001 are arranged in the sliding chutes. The electric sliding rails 1001 slides through upper parts of the clamping frames 10, and the clamping frames 10 are connected to the connecting frames 201 through the electric sliding rails 1001. When the AMR device 12 detects that there is an obstacle in front of the wheelchair, and the obstacle is relatively low but will cause damage to the AMR device 12, a controller drives the clamping frames 10 to move backward through the electric sliding rails 1001 to move the AMR device 12 backward, thereby avoiding the obstacle by changing the travelling direction of the front moving wheels 1 and providing anti-damage protection for the AMR device 12.

It is worth noting that the tops of the two clamping frames 10 protrude and are jointly screwed with a two-directional adjustment screw rod 11, and the tops of the two clamping frames 10 are further slidably connected with a first guide rod 8 parallel to the two-directional adjustment screw rod 11. One end of the two-directional adjustment screw rod 11 is provided with an adjustment handle. The two-directional adjustment screw rod 11 is driven through the adjustment handle to rotate, thereby driving the two clamping frames 10 to move horizontally along the first guide rod 8, so as to realize the two clamping frames to approach or move away from each other, thereby clamping or releasing the AMR device to clamp or release the AMR device.

In addition, second guide rods 901 are arranged on outer walls of the clamping frames 10, and through slots penetrating through the clamping frames 10 are arranged below the second guide rods 901 on the clamping frames 10. The second guide rods 901 slidably penetrates through the clamping blocks 9, and the clamping blocks 9 slide through the through slots of the clamping frames 10. The ends of the clamping blocks 9 that slide through the clamping frames 10 are slopes; and orientations of the slopes are consistent with the travelling direction of the wheelchair. This setting limits the front end of the AMR device 12. Meanwhile, to mount the AMR device 12, the slopes of the clamping blocks 9 are pressed and the clamping blocks 9 move towards end portions of the second guide rods 901, thereby providing convenience for mounting the AMR device 12. Elastic members are arranged between the end portions of the second guide rods 901 and the clamping blocks 9. The elastic members are wound around the second guide rods 901. The elastic members may be springs or rubber members with elastic properties and are functioned to keep the clamping blocks 9 slidably penetrable through the through slots of the clamping frames 10 to limit the front end of the AMR device 12. After the clamping blocks 9 are compressed, a reset elastic force is provided for the resetting of the clamping blocks 9. Preferably, this embodiment selects springs 902, which are compression springs.

Further, outer walls of left and right sides of the connecting frames 201 are hinged with supporting plates 7. Cylinders 702 for driving the supporting plates 7 to flip are arranged at bottoms of the connecting frames 201. Movable ends of piston rods of the cylinders 702 are connected to the supporting plates 7. When the wheelchair tilts to one side, the extension of the piston rods of the cylinders 702 drives the supporting plates 7 to flip upward around hinges with the connecting frames 201, thereby providing a lateral support for the wheelchair through the supporting plates 7 to prevent the wheelchair from tipping over. The flip angle of each supporting plate 7 is less than 90 degrees. Antiskid pads 701 are arranged at bottoms of the supporting plates 7 to improve a friction coefficient between the supporting plates 7 and the ground, thereby improving the safety of the wheelchair.

During use, the two-directional adjustment screw rod 11 is driven to rotate by rotating the handle, and the two-directional adjustment screw rod 11 rotates to drive the two clamping frames 10 to approach or move away from each other along the first guide rod 8, thereby adjusting the distance between the two clamping frames 10, to effectively clamp AMR devices 12 of different specifications. Meanwhile, by adjusting the distance between the two clamping frames 10, the AMR devices 12 on the two clamping frames 10 can be easily removed, achieving an effect of conveniently removing the AMR devices 12. When the AMR device 12 detects that there is an obstacle in the travelling direction, the obstacle avoidance system inside the AMR device 12 sounds an obstacle avoidance alarm. The electric sliding rails 1001 drive the two clamping frames 10 to move horizontally backward, thereby avoiding damage caused by collision between the AMR device 12 and the obstacle. Meanwhile, the guide system controls the front moving wheels 1 to adjust the forward direction, thereby avoiding the obstacle. When the wheelchair tilts to one side, the control system controls the cylinder 702 on the tilted side to operate. The piston rod of the cylinder 702 extends to drive the supporting plate 7 to rotate away from the wheelchair by taking the hinge with the connecting frame 201 as a center, thereby supporting the tilted side of the wheelchair and avoiding the wheelchair from tipping over. Under the action of the elastic forces of the springs 902, the clamping blocks 9 pass through the clamping frames 10 and limit the AMR devices 12 on the two clamping frames 10. The slopes are arranged forward to facilitate the mounting of the AMR devices 12. The AMR devices 12 only need to be pressed backward, and the AMR devices 12 press the clamping blocks 9. The clamping blocks 9 compress the springs 902, thus providing convenience for the mounting of the AMR devices 12.

The above description is only an implementation example of the present disclosure and is not intended to limit the present disclosure. Any equivalent substitution made within the principles of the present disclosure shall fall within the scope of protection of the present disclosure. The content not elaborated in detail in the present disclosure belongs to the existing technology known to those skilled in the art.

What is claimed is:

1. An autonomous mobile robot (AMR) wheelchair capable of achieving autonomous monitoring, operation, and guidance, comprising a wheelchair frame, fixed moving wheels mounted on front and rear sides of a bottom of the wheelchair frame to achieve movement of the wheelchair, a foot rest mounted at a front part of the wheelchair frame to support the feet of a user, and arm rests arranged on two sides of the wheelchair frame, wherein the AMR wheelchair further comprises connecting frames arranged at the bottom of the wheelchair frame and a pair of clamping frames movably arranged on the connecting frames; the pair of clamping frames approach each other or move away from each other to clamp or release an AMR device below the foot rest; the two clamping frames move away from each other to release the AMR device, so that the AMR device is conveniently separated from the two clamping frames; a monitoring system and a guide system are arranged in the AMR device; the monitoring system dynamically plans an optimal path from a start point to an end point according to positioning information of a pickup point and a get-off point in the AMR device and real-time environment information; the guide system performs obstacle avoidance guidance on a detected obstacle to achieve safe passing; clamping blocks are slidably arranged on the clamping frames; and the clamping blocks are configured to limit the AMR device on a placement platform formed by the two clamping frames.

2. The AMR wheelchair capable of achieving autonomous monitoring, operation, and guidance according to claim 1, wherein the monitoring system comprises a sensor configured to monitor an environment in real time and acquire corresponding data, a positioning device for tracking a real-time position of the AMR wheelchair, and an algorithm unit for plan a travel path in real time in conjunction with an environmental topographic map constructed by the acquired real-time data and roadblock information fed back by an obstacle avoidance system.

3. The AMR wheelchair capable of achieving autonomous monitoring, operation, and guidance according to claim 1, wherein the monitoring system further comprises a monitoring and operation unit configured to monitor a state of the AMR wheelchair and monitor a fault.

4. The AMR wheelchair capable of achieving autonomous monitoring, operation, and guidance according to claim 1, wherein the clamping frames are connected to the connecting frames in a manner of being slidably connected to electric sliding rails slidably arranged on the connecting frames.

5. The AMR wheelchair capable of achieving autonomous monitoring, operation, and guidance according to claim 4, wherein a two-directional adjustment screw rod and a first guide rod are movably arranged at tops of the two clamping frames; the two-directional adjustment screw rod and the first guide rod are parallel to each other; and the two-directional adjustment screw rod is configured to drive the two clamping frames to approach or move away from each other.

6. The AMR wheelchair capable of achieving autonomous monitoring, operation, and guidance according to claim 5, wherein a second guide rod is arranged on an outer wall of each clamping frame; the second guide rods slidably penetrate through the clamping blocks, and the clamping blocks slide the clamping frames; and elastic members are arranged between end portions of the second guide rods and the clamping blocks.

7. The AMR wheelchair capable of achieving autonomous monitoring, operation, and guidance according to claim 6, wherein shock absorbers for absorbing shock are arranged at joints between the moving wheels and the wheelchair frame.

8. The AMR wheelchair capable of achieving autonomous monitoring, operation, and guidance according to claim 7, wherein two outer walls of the connecting frames are hinged with supporting plates; cylinders for driving the supporting plates to flip are arranged at bottoms of the connecting frames; and movable ends of piston rods of the cylinders are connected to the supporting plates.

9. The AMR wheelchair capable of achieving autonomous monitoring, operation, and guidance according to claim 8, wherein a flip angle of each supporting plate is less than 90 degrees.

10. The AMR wheelchair capable of achieving autonomous monitoring, operation, and guidance according to claim 9, wherein ends of the clamping blocks that slide through the clamping frames are slopes; and orientations of the slopes are consistent with the travelling direction of the wheelchair.
